(19) United States
(12) Patent Application Publication
(10) Pub. No.: US 2018/0039734 A1
(43) Pub. Date: Feb. 8, 2018

(54) METHOD AND SYSTEM FOR PROVIDING MEDICAL ADVICE ABOUT TREATMENT OF A CONDITION OF A USER

(71) Applicant: INSTANT ADVICE AB, Lund (SE)

(72) Inventors: Olof Jarlman, Lund (SE); Tord Wingren, Malmö (SE); Mårten Rignell, Dalby (SE)

(73) Assignee: INSTANT ADVICE AB, Lund (SE)

(21) Appl. No.: 15/555,985

(22) PCT Filed: Mar. 4, 2016
(86) PCT No.: PCT/SE2016/050176

§ 371 Date: Sep. 6, 2017

(30) Foreign Application Priority Data
Mar. 6, 2015 (SE) 1550273-5

(51) Int. Cl. G06F 19/00; G06T 7/00; G06F 17/30

(52) U.S. Cl. CPC G06F 19/321; G06F 19/345; G06F 17/3028; G06T 7/0016; G06T 2200/24; G06T 2207/30196

(57) ABSTRACT

A method is disclosed for providing advice to a user about treatment of a condition of the user. The method comprises: receiving an image depicting the condition; processing (306) and adapting the image to a standardized model; transferring (308) the processed image to an analysis module (108); receiving a quantified measure of the condition from the analysis module (108); calculating (312) a measurement score based on the quantified measure, the measurement score describing a state of the condition; transferring (320) historical values of the measurement score, the calculated measurement score, and personal information about the user as input to an advice module (114), which provides rules for correlating input to advice for treatment of the condition; processing (322) the received input in order to automatically determine appropriate advice for treatment of the condition; and transferring (324) the determined advice to an application for presenting the determined advice to a user.

### TECHNICAL FIELD

The invention disclosed generally relates to providing of advice to a user about treatment of a condition of the user. In particular, the invention relates to a method, a computer program product and a system for providing advice.

### BACKGROUND

People of today are inclined to find solutions on their own to any problem or condition they may suffer from. Enormous amounts of information are freely available, e.g. on the Internet, and it is therefore possible for anybody to find out information about a certain problem or condition.

However, with the enormous amounts of information available, it is difficult to sort out the most relevant information. Also, solutions or advice may not exactly fit to the specific circumstances of the person seeking information and, therefore, the best solution or advice may be difficult to find.

Hence, even though the information is available, a person may not easily find an appropriate solution or even be able to identify the appropriate solution by searching the Internet.

In particular, there are conditions that a person may suffer from, which do not necessarily need attention by a physician, but still the person would like to treat the condition. Such conditions may be acne, age wrinkles, or discoloured teeth. The person may need advice for effectively treating the condition. However, since a party giving advice does not need to have a medical license, the amount of available treatment advice may be enormous and the quality of treatment advice may often be questionable.

Therefore, it would be desirable to provide a person wanting to treat a condition with a way to obtain appropriate advice to treatment of the condition. Even though it may be particularly useful for treatment of conditions that do not need attention by a physician, it may also be desirable to provide advice to treatment of a medical condition, wherein the advice may complement medical care provided by a physician.

It is known, from US 2011/087807, a system and method for diagnosing melanoma from digital images taken by a remote user with a smart phone and transmitted to an image analysis server in communication with a distributed network. However, this method is merely used as a preliminary screening tool and may not be used for providing advice to the user for continuous treatment of the condition.

### SUMMARY OF THE INVENTION

It is an object of the invention to enable a method that may selectively provide advice to a user about treatment of a condition of the user, wherein the advice pertains to the specific state of the condition of the user.

This and other objects of the invention are at least partly met by the invention as defined in the independent claims. Preferred embodiments are set out in the dependent claims.

According to a first aspect of the invention, there is provided a method for providing advice to a user about treatment of a condition of the user, said method comprising: receiving an image of the user, wherein the image depicts the condition; processing the image in relation to a standardized model of depicting the condition such that the image is adapted to the standardized model; transferring the processed image to an analysis module; receiving at least one quantified measure of the condition from the analysis module, wherein the quantified measure is based on the image; calculating a measurement score based on the at least one quantified measure, the measurement score describing a state of the condition; storing the image in a database in association with the at least one quantified measure and/or the calculated score; transferring historical values of the measurement score of the user, the calculated measurement score, and personal information about the user as input to an advice module, which provides rules for correlating received input to advice for treatment of the condition; processing, by the advice module, the received input in order to automatically determine appropriate advice for treatment of the condition; and transferring the determined advice to an application for presenting the determined advice to a user.

According to a second aspect of the invention, there is provided a computer program product comprising a computer-readable medium with computer-readable instructions for performing the method of the first aspect of the invention.

According to a third aspect of the invention, there is provided a system for providing advice to a user about treatment of a condition of the user, said system comprising: an image processing module, said image processing module being configured to receive an image of the user, wherein the image depicts the condition and to process the image in relation to a standardized model of depicting the condition such that the image is adapted to the standardized model; a measurement score calculator, said measurement score calculator being configured to receive at least one quantified measure of the condition, wherein the quantified measure is based on the image, and calculate a measurement score based on the at least one quantified measure, the measurement score describing a state of the condition; a database storing the image in association with the at least one quantified measure and/or the calculated score; and an advice module, said advice module being configured to receive historical values of the measurement score of the user, the calculated measurement score, and personal information about the user as input, said advice module providing rules for correlating received input to advice for treatment of the condition and being further configured to process the received input in order to automatically determine appropriate advice for treatment of the condition.

Thanks to the invention, relevant information about the state of a condition of the user is gathered. In particular, an image depicting the condition is received and processed in relation to a standardized model such that the image is adapted to the standardized model. This implies that the information about the state of the condition contained in the image becomes easily extractable. Also, having an image adapted to a standardized model facilitates comparing features in images and, therefore, obtaining a measurement score describing a state of the condition.

Further, rules for correlating received input to advice for treatment of the condition are provided. This implies that advice may be generated in an automatic manner based on historical values of the measurement score of the user, the calculated measurement score, and personal information about the user. Hence, when a user takes an image depicting the condition, advice may automatically and instantly be provided, without a professional necessarily having to analyze the state of the condition before advice may be given.

Thanks to the gathering of images depicting the condition and the determining of quantified measures of the condition, it is possible to provide a training set for teaching an image analysis module to calculate quantified measures of the condition. The storing of the image in a database in association with the at least one quantified measure and/or the calculated score may thus provide the training set. Hence, the quantified measures of the condition may initially be provided by the user or by a professional, whereby a large training set may be gathered. An image analysis module may then use the training set to learn how to automatically calculate quantified measures of the condition.

The method provides a very fast manner of analyzing the condition of the user and providing appropriate advice. Thus, a real-time analysis of the condition may be performed and appropriate advice may be given in real-time.

It should be realized that the image processing module does not necessarily receive a single image of the user. A plurality of images may be simultaneously received, such as a sequence of images, or even one or more video sequences. One or more of the images may then be selected for processing in order to determine appropriate advice or all received images may be used for determining appropriate advice.

According to an embodiment, said processing, by the advice module, comprises comparing received input to pre-defined parameter values for determining appropriate advice and selecting from a set of pre-defined advice stored by the advice module, the appropriate advice corresponding to the received input based on said comparing. By storing a set of pre-defined advice, the advice module is able to quickly select the appropriate advice that corresponds to the received input. Further, the received input is compared to pre-defined parameter values such that a combination of parameter values may be correlated to a specific advice among the set of pre-defined advice.

According to another embodiment, the method further comprises storing information indicating a previously selected advice for the user and said selecting of the appropriate advice being further based on the stored information indicating the previously selected advice. This implies that the previously selected advice may be used as input for more quickly determining the appropriate advice to be presented to the user. Further, the previously selected advice may be used for improving a determination of appropriate advice. For instance, a result of a treatment based on the previously selected advice may be correlated to the selected advice such that an effectiveness of different advice may be determined and used for updating rules for correlating received input to appropriate advice for treatment of the condition.

The method may also comprise storing selected advice and results of treatments of users in the database. Thus, the database may store information relating treatment results and information of the performed treatments, such as advice given during the treatment. This implies that information about which advices are effective in achieving a good result of the treatment may be gathered and used for improving the advice to be given in later treatments.

The performed treatments may be stored in association with personal information about the user on which the treatment was performed, such that a pattern may be found regarding which advice may be effective depending on the personal information about the user, such as age, gender, skin type, etc.

The advice module may thus fetch previously provided advice which provided a good treatment result, wherein the previously provided advice may be selected based on received input, such as personal information about the user. This previously provided advice may be provided as further input to the advice module for determining appropriate advice.

According to an alternative, the advice module may first determine a set of potentially appropriate advice. Then, the set of potentially appropriate advice may be compared to information on effectiveness of performed treatments for selecting the appropriate advice among the set of potentially appropriate advice.

It is also an insight of the invention that effectiveness of advice is highly dependent on how the advice is perceived by the user. Often, the treatment of the condition may be related to changing a habit of the user, and it may require substantial encouragement to ensure that the user actually changes habits. Thus, the advice may need to speak to the user on a psychological level. By means of storing information of advice and associated treatment result, a database of advice that have been effective in ensuring that a user sticks to a treatment may be built up. The method and system is therefore able to learn which advice may be effective so as to improve the advice to be given for future treatments.

It is also realized that, since the effectiveness of performed treatments may to a large extent be based on changing habits, the advice need to be correct from a psychological point of view. For instance, effectiveness of treatment of conditions is often dependent on the user being consistent with actually regularly performing the necessary treatment actions, such as applying a facial cream for treating acne.

It is further realized that there are many aspects of life that are affected by habits. Thus, the treatment of a condition of a user may be extended to not merely treating physical conditions. An advice module which is able to learn the effectiveness of advice in changing habits may therefore be used for helping a user to improve any condition or performance that is affected by habits of the user. For instance, the condition may be a psychological condition, such as an eating disorder. Alternatively, the advice module may give advice for helping the user to improve a golf swing, or other movement patterns.

According to another embodiment, the method further comprises identifying specific input received by the advice module as particularly important, wherein said processing, by the advice module, comprises comparing said specific input to at least one pre-defined parameter value, and skipping at least one comparison of received input to pre-defined parameter values based on said specific input meeting the at least one pre-defined parameter value.

Thus, by identifying that specific input may be of particular importance, the advice module may quickly obtain the appropriate advice, as some comparison(s) of input to pre-defined parameter values may be obsolete in view of the specific input meeting its associated parameter value.

According to one embodiment, the method comprises receiving subjective information relating to the user's experience of the condition, and transferring said subjective information as input to the advice module, wherein the subjective information may be identified as specific input of particular importance.

By giving advice based on subjective information and objective values, the advice may take into account the user's experience of the condition, which need not correspond to an objective measurement of the condition. Often, users discontinue a treatment too early, e.g. because the treatment may initially not improve the condition or that a condition is improved and the user does not have the patience to continue the treatment to avoid that the condition reappears. The advice may thus be adapted to the subjective information so as to e.g. encourage the user to continue with a treatment and not give up too early.

Further, the advice module may quickly obtain an appropriate advice, as input relating to subjective information may be given high weight allowing other input to be skipped. For instance, the rules may be formed as a decision logic, wherein a decision path through the decision logic for determining the appropriate advice may be shortened by means of finding that subjective information meets a certain parameter value.

According to an embodiment, said processing of the image in relation to a standardized model comprises presenting a standardized model to a user for aiding the user in adapting the image to the standardized model, receiving processing input from the user relating the image to the standardized model, and processing the image using the processing input.

The presenting of a standardized model to a user may include storing information defining the standardized model and transferring the information defining the standardized model to a user equipment allowing the information to be displayed to the user on the user equipment. Thus, the user provides processing input which may be used to adapt the image to the standardized model. However, the standardized model is presented to the user in order to aid the user in providing input and therefore improving the adaption of the image to the standardized model.

For instance, the image and the standardized model may be presented in a superposed manner with at least one of the image and the standardized model being partly transparent. The user may thus fit the image to the standardized model. The user may also be presented with a temporary adaption of the image in order to select processing input which best fits the image to the standardized model.

According to another embodiment, the standardized model comprises information of image features and placement of the image features in the standardized model, and wherein said processing of the image in relation to a standardized model comprises extracting image features in the image and processing the image in order to adapt the placement of the extracted image features to the placement of the image features in the standardized model. This implies that the image may be adapted to the standardized model by means of an image processing module that automatically extracts image features in the image and processes the image in order to fit the extracted image features to placement of corresponding image features in the standardized model.

According to an embodiment, the method further comprises analyzing the processed image, by the analysis module, wherein said analyzing comprises extracting measurement features in the image; and comparing the extracted measurement features to stored definitions of features of interest in order to automatically determine said at least one quantified measure of the condition. The analysis module may be provided with rules for extracting measurement features and for evaluating the measurement features. Since the image is adapted to a standardized model, the measurement features that are extracted from the processed image may be easily assessed against stored definitions of features of interest, whereby a reliable result may be obtained from an automatic determination of said at least one quantified measure. The stored definitions may for instance be exemplary images of a feature of interest, such that an extracted feature may be compared for similarity to the exemplary image. The stored definitions may also or alternatively comprise a stored value or range of values of an image processing function performed on a feature in an exemplary image. Hence, if the image processing function is performed on an extracted measurement feature from the image, the result of the image processing function may be compared to such a stored value.

According to another embodiment, the method further comprises presenting the processed image, by the analysis module, to a user together with a historical image of the user and a value of said at least one quantified measure of the condition as determined in the historical image in order to aid the user in determining said at least one quantified measure of the condition in the processed image. Hence, a user may be prompted to determine the at least one quantified measure and may be aided in the determination by the presentation of a historical image and a value of the quantified measure relating to the historical image. This implies that the user may provide a reliable determination of the at least one quantified measure, since it is provided in relation to a historical measure. Also, the user-determined quantified measure of the condition may be used in a training set for teaching an image analysis module to automatically calculate quantified measures of the condition.

According to yet another embodiment, the method further comprises presenting the processed image, by the analysis module, to a professional user, such that the professional user may determine said at least one quantified measure of the condition in the processed image and return a professionally determined quantified measure. In teaching an image analysis module to automatically calculate quantified measures of the condition, it may be very helpful to provide professional analysis of the condition as input to the training set. Hence, when a method for providing advice to a user about treatment of a condition of the user has been newly released, professional analysis of the processed images may be performed until an image analysis module perform satisfactory automatic analysis.

According to an embodiment, the method further comprises determining a point in time at which an image of the user is to be acquired and prompting the user to acquire the image. This implies that the method may control that images are acquired such that progress of the condition of the user may be followed.

According to an embodiment, said processing by the advice module is made in response to receiving an image of the user and receiving at least one quantified measure of the condition. This implies that advice may be provided to the user in response to an image being received. If the user is further prompted to acquire the image, the advice may be provided according to a pre-defined schedule.

According to an embodiment, the method further comprises receiving environment information describing external parameters that may affect the condition of the user, and transferring the environment information as input to the advice module. The environment information may provide further input to the advice module such that the advice may be adapted to changes in the external parameters.

Further, said processing by the advice module may be made in response to receiving updated environment information describing a change of said external parameters. Hence, advice may be provided in response to changes of the external parameters, such that a user may be provided with updated advice corresponding to changes not only to the determined state of the condition of the user but also if external parameters which may affect the condition of the user are changed.

According to an embodiment, the condition of the user is a cosmetic condition, such as discoloured teeth or a skin condition, such as acne, or age wrinkles.

According to other embodiments, the condition of the user is not necessarily a cosmetic condition, but may affect the outer appearance of a person. The condition may e.g. be open or closed wounds, burns, or psoriasis.

According to an embodiment, the method further comprises receiving information pertaining to an impact on quality of life of the user in relation to the user's perception of the condition; calculating an index score of the impact on quality of life of the user; and transferring the index score as input to the advice module. A user's perception of the condition may differ from the actual state of the condition. Also, the effect on the quality of life of a user caused by the condition may differ between different users and may not be directly related to the actual state of the condition. Thus, the index score may provide a measure of the impact on quality of life of the user, which may also affect what advice is appropriate. Therefore, the advice module may receive the index score as input and use it in determining appropriate advice. The index score may constitute subjective information relating to the user's experience of the condition.

In commencing a treatment, or even during treatment of the condition, it may be of great value to the user to get an indication of a result of the treatment. Such an indication of the result may provide a motivation to the user to continue or start the treatment. Thus, according to one embodiment, the method may further comprise determining a predicted result of the treatment based on the processed image, information of treatment results of previously performed treatments, and information about the treatment to be performed.

Further, according to a separate aspect, which may or may not be combined with the method of providing advice as described above, there is provided a method of predicting a result of a treatment of a condition of a user to be treated, said method comprising: receiving an image of the user, wherein the image depicts the condition, processing the received image according to a prediction calculation algorithm, which has access to information of treatment results of performed treatments, wherein said treatment results are associated with information about the performed treatments, comprising at least one of: personal information of a user to which the treatment was performed, and treatment information, comprising information of a product used in the performed treatment and a treatment scheme of the performed treatment; wherein the prediction calculation algorithm also has access to information about the treatment to be performed, comprising at least one of: personal information about the user to be treated, and planned treatment information, comprising information of a product to be used in the treatment and a treatment scheme of the treatment; said processing comprising: identifying areas in the image comprising features relating to the condition, calculating a predicted result of the treatment in the identified areas based on the information of treatment results of performed treatments and the information of the treatment to be performed, and producing a prediction image based on the received image and the calculated predicted result of the treatment in the identified areas.

The prediction calculation algorithm may thus make use of known treatment results to predict a result on a user to be treated. Thanks to a prediction image being produced based on an image of the user, a result of the treatment may be visualized to the user. Further, the prediction image provides a plausible appearance of the user after the treatment. This may be much more effective in motivating the user to perform the treatment in relation to providing “before” and “after” images of typical results of the treatment.

The personal information of the user may comprise information about e.g. age, gender, ethnicity or nationality, exercise, smoking and eating habits, which may have a general effect on the condition. The information of a treatment scheme may comprise information about a frequency of use of a product, and an amount or dosage of use of the product.

The information about the performed treatments and the information about the treatment to be performed may further comprise information of other conditions that may affect the result of the treatment. Such information of other conditions may include information about medications that the user is taking or information of environment conditions during a period of treatment, such as a season (winter, spring, summer, fall) during which the treatment is performed.

In one embodiment, the processing of the prediction calculation algorithm may comprise selecting relevant treatment results by comparing the information about the treatment to be performed to the information about the performed treatments. Then, the selected relevant treatment results are used in the calculation of the predicted results. Thanks to the treatment results being associated with information concerning the performed treatment, results of previously performed treatments that may have given similar results to what may be expected from the treatment to be performed may be identified and selected. This implies that the prediction of the result of the treatment of the condition may be more reliable.

In one embodiment, the processing of the prediction calculation algorithm may further comprise determining an image transformation based on a weighting of the selected relevant treatment results, wherein said image transformation defines a transformation of an image area comprising features relating to the condition to an appearance of the area after treatment. The prediction calculation algorithm may compute an image transformation for each of the selected relevant results, which image transformation describes a transfer of an image area comprising features relating to the condition to the appearance of the image area after treatment. Alternatively, such image transformations for the selected relevant results may have been previously determined and the prediction calculation algorithm may have access to these image transformations.

The weighting of the selected relevant treatment results may be used to determine an average or a weighted average image transformation. The determined image transformation may comprise a number of individual elements or parameters which together define the image transformation. Each such element or parameter may be individually determined using a weighting of the selected relevant treatment results. Alternatively, the image transformation may be determined by computing a linear or non-linear function of the image transformations of the selected relevant treatment results.

In one embodiment, the prediction calculation algorithm determines a predicted appearance of the identified areas. The producing of a predicted image may then comprise replacing the identified areas of the received image with a predicted appearance of the respective areas. Further, the producing of a predicted image may comprise smoothing of edges of the identified areas. This implies that when the identified areas are replaced with a predicted appearance, the replaced area may be fitted to the received image in order to avoid that the edges of the replaced areas are visible in the predicted image.

In one embodiment, the method of predicting a result is performed based on an on-going treatment. Thus, the received image may be an image of the current state of the condition of the user. Further, the prediction calculation algorithm may also have access to treatment results so far of the user to be treated. Such treatment results may indicate a likely result of further treatment of the condition and may be used in the calculating of a predicted result of the treatment in the identified areas. This implies that the prediction of a result need not be static during treatment of a condition. Rather, the prediction may be dynamically updated when new images of the condition are taken. Thus, an initial prediction of the result may eventually become a prognosis of an end result of the treatment.

### BRIEF DESCRIPTION OF DRAWINGS

These and other aspects of the present invention will now be described in further detail, with reference to the appended drawings showing embodiment(s) of the invention.

FIG. 1 is a schematic view of a system according to an embodiment of the invention.

FIG. 2 is a block representation of a process of providing advice to a user according to an embodiment of the invention.

FIG. 3 is a flowchart of a method according to an embodiment of the invention.

FIG. 4 is a schematic view of an advice module of the system.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, to fully convey the scope of the invention to the skilled person.

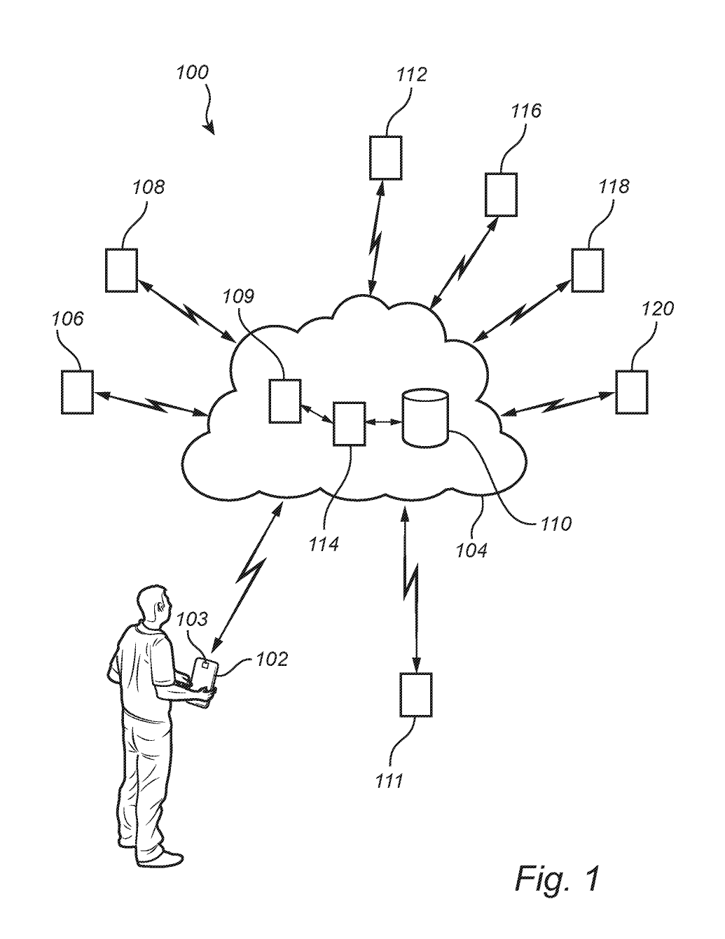

Referring now to FIG. 1, a system 100 for providing advice to a user about treatment of a condition of the user will be described. The advice may be provided several times, e.g. periodically or at appropriate times, during treatment of the condition such that the advice may help the user to treat the condition appropriately during an entire process of treating the condition. Further, the system 100 may also monitor the condition of the user, even after a finalized treatment process, in order to enable detecting at an early stage if the condition is re-appearing. Gathering of information, such as images, as explained below, may be performed at a lower rate when a condition is merely monitored and no longer actively treated.

The user may interact with a user equipment 102. The user equipment 102 may be any type of portable device having computer processing capability, such as a mobile phone or a tablet computer. However, the user equipment 102 may also or alternatively be a stationary computer.

The user equipment 102 may thus comprise a processing unit, which may execute an application. The application may be specifically adapted for the system 100, but may also be implemented as a conventional web browser, which may direct browsing to a designated address. The user equipment 102 further comprises a communication unit, such that the user equipment 102 may transmit and receive information. The communication unit may, for instance, be arranged to communicate with a central application unit 104, which may be connected to a computer network, such as a wireless local area network (WLAN) or the Internet.

The user equipment 102 may further comprise or may be connected to sensors, for acquiring information regarding the condition of the user. In particular, the user equipment 102 may comprise a camera 103, or may be connected to, a camera, such that an image depicting the condition of the user may be acquired. The user equipment 102 may further comprise, or may be connected to, a position sensor, such as a Global Positioning System (GPS) sensor, for obtaining information of a location of the user.

The user equipment 102 may additionally or alternatively comprise or be connected to further sensors, such as a sensor for measuring skin thickness of the user, and sensors for measuring environment parameters, such as intensity of sun light, temperature and humidity.

The central application unit 104 may be arranged to control a process for providing advice to the user. The central application unit 104 may be implemented in hardware, or as any combination of software and hardware. The central application unit 104 may, for instance, be implemented as software being executed on a general-purpose computer, as firmware arranged e.g. in an embedded system, or as a specifically designed processing unit, such as an Application-Specific Integrated Circuit (ASIC) or a Field-Programmable Gate Array (FPGA). In a specific embodiment, the central application unit 104 comprises a server unit, which is provided with a computer program for controlling the server unit to perform a process for providing advice to the user.

The central application unit 104 may be connected to a computer network, such as the Internet, for communicating with a plurality of user equipments 102 associated with respective users.

An application executed by the user equipment 102 may be set up to communicate with the central application unit 104, such that the application in the user equipment 102 may establish communication with the central application unit 104 once the application is started in the user equipment 102. The central application unit 104 may provide push notices to the application for alerting the user to available information without the application even being started in the user equipment 102. The central application unit 104 may also direct the user equipment 102 to internal or external information sources, such as websites, for presenting information to the user of the user equipment 102. Thus, the central application unit 104 may control the presentation of information to the user of the user equipment 102.

The central application unit 104 may further be arranged to communicate with a plurality of different modules. These modules may be implemented as processes within a processor of the central application unit 104 or may be implemented in separate processing units or as interface applications, which may communicate with the central application unit 104.

The central application unit 104 may be arranged to receive information relating to the condition of the user from the user equipment 102. The information relating to the condition of the user may comprise personal information about the user, which the user may provide at one or several times when starting to use the application, and which may further be updated when the information changes. The personal information may comprise information about e.g. age, gender, ethnicity or nationality, exercise, smoking and eating habits, which may have a general effect on the condition or recommended treatment. The personal information may also comprise specific information that may specifically apply to the condition, such as skin type, sun bathing habits, and products or medication currently used for treatment of the condition or used for treatment of other conditions. The central application unit 104 may further be arranged to receive sensor information acquired by sensors of the user equipment 102. Such sensor information may provide input regarding a current state of the condition of the user. The sensor information may also provide general information relating to the user, such as a GPS position, or environment information, such as intensity of sun light, temperature and humidity. The central application unit 104 may be arranged to transfer the sensor information to modules for processing and analyzing the sensor information.

In an embodiment, the sensor information is an image depicting the condition of the user. The system 100 may then further comprise an image processing module 106, which may be arranged to receive the image and may process the image such that the image is adapted to a standardized model.

The user may acquire a plurality of images using the user equipment 102. The plurality of images may be received by the processing module 106. For instance, the plurality of images may be a sequence of images, or a video sequence. The processing module 106 may process all the received images. Alternatively, the processing module 106 may select one or more images among the received images, or may extract an image from a video sequence, for use in further processing.

Below, the system 100 is described in relation to a single image for brevity. However, it should be realized that a plurality of images may be separately processed or processed together for analysis of the condition of the user.

The system 100 may further comprise an image analysis module 108, which may be arranged to determine at least one quantified measure of the condition of the user based on the processed image.

The image processing module 106 and the image analysis module 108 may be implemented in separate units or a combined unit of software, hardware, or any combination of software and hardware. The image processing module 106 and the image analysis module 108 may, for instance, be implemented as software being executed on a general-purpose computer, as firmware arranged e.g. in an embedded system, or as a specifically designed processing unit, such as an ASIC or a FPGA.

The image processing module 106 may be arranged to automatically process the image such that the image is adapted to a standardized model. Alternatively, the image processing module 106 may be arranged to present information in order to aid a user in providing input to the image processing module 106 for adapting the image to a standardized model. The image processing module 106 may then process the image based on the input from the user.

The image analysis module 108 may be arranged to automatically extract features in the processed image and to generate at least one quantified measure of the condition based on the extracted features. Alternatively, the image analysis module 108 may be arranged to present information in order to aid a user in performing an analysis of the processed image and to provide input for generating at least one quantified measure of the condition.

The processes performed by the image processing module 106 and the image analysis module 108 will be further described below.

The central application unit 104 or the image analysis module 108 may further comprise a measurement score calculator 109, which is arranged to calculate a measurement score based on the at least one quantified measure. The measurement score describes a state of the condition of the user.

The measurement score calculator 109 may also determine a reliability of the determined measurement score. Alternatively, the image processing module 106 and/or the image analysis module 108 may determine a quality of an image such that a reliability of a measurement score may be determined in advance. If it determined that the measurement score has a very low reliability, the user may be prompted to acquire a new image.

The central application unit 104 may further comprise a database 110, wherein processed images may be stored in association with further information about the image, such as an identifier of the user, the at least one quantified measure determined for the image and the calculated measurement score, and information from other sensors connected to the user equipment 102. The central application unit 104 may thus comprise a memory for storing the database 110. The memory may be accessible to the image analysis module 108, such that the image analysis module 108 may use entries in the database as a training set for teaching the image analysis module 108 to determine the at least one quantified measure from images depicting the condition.

The application in the user equipment 102 may further comprise an interface for providing subjective information. The user may thus input information to subjectively grade a severity of the condition. In one embodiment, such subjective information may be an indication whether the condition subjectively has improved, deteriorated or not changed. The subjective information may be given a value based on indicated levels of the change of the condition. The subjective information may also relate to specific aspects of the condition, such that the user may provide several indications of how the condition has changed.

In one embodiment, the subjective information may pertain to an impact on life quality of the user in relation to the user's perception of the condition. The interface may e.g. provide a questionnaire prompting the user to respond to questions relating to the life quality. The questions may be multiple-choice questions allowing a score to be related to each answer. The answers provided by the user may be transferred to the central application unit 104.

The system 100 may further comprise an index score calculator 111, which may receive the answers to the questionnaire provided by the user. The index score calculator 111 may comprise an algorithm for calculating an index score based on answers to the questionnaire. The calculated index score may indicate an impact on life quality of the user in relation to the condition, such as a severe psychological problem or a minor effect on the mood of the user assignable to the user's perception of the condition and the impact it has on the general life quality. The index score may be used for identifying users whose entire life situation is affected by the condition. The index score may also be used for measuring how treatment of a condition may affect how users' life quality is improved and how it relates to the actual effect of the treatment on the condition.

The system 100 may further comprise an environment information module 112. The environment information module 112 may be arranged to collect environment information from internal or external sources. The environment information may describe external parameters that may affect the condition of the user. For instance, the external parameters may be weather information, which may affect a skin condition, such as acne. The environment information module 112 may thus be arranged to collect weather information from a weather source, such as temperature, humidity, and sun conditions.

The central application unit 104 may further comprise an advice module 114. The advice module 114 may, for instance, be implemented as software being executed on a general-purpose computer, as firmware arranged e.g. in an embedded system, or as a specifically designed processing unit, such as an ASIC or a FPGA, or embedded in a local application on the user equipment 102.

The advice module 114 may be arranged to receive historical values of the measurement score of the user, the calculated measurement score of a currently received image, and personal information about the user as input. The historical values and the personal information about the user may be fetched from the database 110. The advice module 114 may also receive a value defining the reliability of the measurement score. The advice module 114 may optionally also be arranged to receive environment information from the environment information module 112 as input. Further, the advice module 114 may also receive the calculated index score from the index score calculator 111 as input. Also, the advice module 114 may receive information from other sensors connected to the user equipment 102, which information may or may not be pre-processed before being provided to the advice module 114.

The advice module 114 may provide rules for correlating received input to advice for treatment of the condition. Hence, the advice module 114 may e.g. provide software instructions for applying the received input to the rules such that appropriate advice for treatment of the condition may be generated or returned from the advice module 114.

The advice module 114 may also store information relating to the provided advice in the database 110 or in a separate database. The provided advice may be stored associated to the user and a progress of treatment of the condition of the user may also be stored in the database 110. Thus, the database 110 may store information regarding treatment results in association with the provided advice during treatment.

The advice module 114 may also use the information regarding provided advice and results of treatments when the advice was provided, as input for determining appropriate advice. This input may improve the possibility of the advice module 114 to determine the appropriate advice for the user. In particular, it may be possible to determine an effectiveness of advice by the previously provided advice being stored in association with treatment results.

The central application unit 104 may be arranged to transfer the determined advice to the user equipment 102, such that the determined advice may be presented to the user by the user equipment 102. Historical values of the measurement score and the measurement score for the current image may also be transferred to the user equipment 102 such that a progress of a state of the condition may be presented to the user.

The advice may be transferred to the user equipment 102 as soon as it is determined. However, the advice may alternatively be transferred after a pre-determined delay or according to a defined schedule of providing advice, such as once or twice per day.

The system 100 may further be arranged to provide a prediction of a result of the treatment. As a basis for predictions, the database 110 may store information of treatment results of performed treatments. The information of treatment results may include at least one image depicting the condition of a user before or during treatment and an image depicting the condition after the treatment. Thus, the treatment result may be evident as a difference between the image before treatment and the image after treatment.

The effect on the condition achieved by a treatment may be defined by an image transformation that is required for transforming an image area comprising features relating to the condition in an image before treatment to the corresponding image area in an image after treatment. Thus, the treatment result may be stored simply as the image transformation caused by the treatment and the actual images pertaining to the performed treatment need not be stored in the database 110.

The treatment results may further be stored in the database 110 in association with information about the performed treatment such that the particular treatment result may be correlated to factors that may affect results of a treatment. This information about the performed treatment may include personal information of the user to which the treatment was performed, e.g. such personal information as exemplified above. The information about the performed treatment may also include treatment information defining a product used in the performed treatment and a treatment scheme of the performed treatment, such as a frequency of use of the product, and an amount or dosage of use of the product. The information about the treatment may also include other types of information that may have an effect on the treatment, such as external conditions, e.g. a season of the year during which the treatment was performed, and internal conditions, e.g. other medications taken by the user.

The image analysis module 108 or a separate module having image analysis functionality may be arranged to determine a prediction of the result of the treatment to be performed. In this regard, the image analysis module 108 may implement and use a prediction calculation algorithm for determining the prediction.

The image analysis module 108 may receive an image depicting the condition of the user. This received image may be a processed image, which is adapted to a standardized model as described above. Alternatively, the received image is an image as acquired by the camera 103 of the user equipment 102, which may or may not have been exerted to simple pre-processing such as eliminating artefacts, e.g. reflexes, from the image.

The prediction calculation algorithm of the image analysis module 108 receives the image as input to the algorithm. Further, the prediction calculation algorithm receives information about the treatment to be performed. The information about the treatment to be performed may comprise the same type of information that is provided about the performed treatments. The information about the treatment to be performed may be based on advice provided by the advice module 114. The prediction calculation algorithm also has access to the information about performed treatments.

The image analysis module 108 may perform processing steps to execute the prediction calculation algorithm. The processing may comprise selecting relevant treatment results by comparing the information about the treatment to be performed to the information about the performed treatments. Thus, among a plurality of treatment results in the database 110, treatment results that are relevant for determining a prediction of the result of treatment for the present user are selected. The selection may be based on at least a predetermined number of parameters specifying the treatment to be performed being met by the performed treatment. Also, some parameters may be given a high weight or be mandatory, such that a performed treatment that does not meet the condition of the parameter cannot be selected as relevant. For instance, in an embodiment to treat acne, the skin type may need to be the same for the treatment to be performed and the performed treatments.

The processing may further comprise identifying areas in the image comprising features relating to the condition. These identified areas will thus be affected by the treatment and the processing may then be based on determining an effect of the treatment on the identified areas. The areas may be identified in the same or similar manner as measurement features are extracted in an image for the determining of a state of the condition, as further described below.

The processing may further comprise calculating a predicted result on each identified area in the image, which may include determining an image transformation to be performed on the identified area. The image transformation should thus transform the identified area to the predicted appearance after the treatment.

The image analysis module 108 may compute or may have access to an image transformation for each of the selected relevant results, which image transformation describes a transfer of an image area comprising features relating to the condition to the appearance of the image area after treatment. The image transformation for the treatment results may be partly determined with help of a professional, indicating relevant areas in the images providing relevant features before and after treatment. The thus known image transformations of the treatment results may then be stored in the database 110. Based on the known image transformations of the selected relevant treatment results, an average or a weighted average image transformation may be determined.

The determined image transformation may comprise a number of individual transformation matrix elements or parameters which together define the image transformation. Each such element or parameter may be individually determined using a weighting of the selected relevant treatment results. Alternatively, the image transformation may be determined by computing a linear or non-linear function of the image transformations of the selected relevant treatment results. The determined image transformation may then be performed on the identified area in order to provide a predicted result of the area.

As a further alternative, the selected relevant treatment results may provide a probable appearance of the identified area after the treatment. Such a probable appearance may be determined as an average or a weighted average of the selected relevant treatment results. A predicted result on the identified area may start from such a probable appearance and may further be adapted to parameters of the user on which the treatment is to be performed. For instance, the probable appearance may be adapted to a skin nuance of the user.

The predicted results of the identified areas may then be merged with the originally received image of the user in order to replace each identified area with its corresponding predicted result. The thus merged image may be further processed with e.g. a smoothening filter in order to remove any border effects in the edges between the original image and the replaced identified areas. Thus, a prediction image may be produced and output from the image analysis module 108.

The prediction image may be transmitted to the user equipment 102 in order to be presented to the user. The prediction image may thus work as a motivator for motivating the user to start or continue a treatment of the condition.

The prediction image may further be complemented with a textual description of the effects of the treatment, pointing out specific improvements of the condition. Such textual description may be determined based on information associated with the treatment results in the database 110. This information may be provided by a professional analyzing the images describing the treatment results and giving a professional opinion on the result.

The prediction of results of the treatment may be performed when a treatment is to be started. However, the prediction may also be updated during treatment. the prediction calculation algorithm may also have access to treatment results so far of the user to be treated. Such treatment results may indicate a likely result of further treatment of the condition and may be used in the calculating of a predicted result of the treatment in the identified areas.

An update of the prediction may be performed when requested by the user. The update may alternatively be performed according to pre-set intervals and may be returned to be presented by the user equipment 102 together with determined advice.

The system 100 may further comprise an electronic commerce site 116 or a connection or pointer to an electronic commerce site 116. The advice provided by the advice module 114 may at least partly relate to products to be used in the treatment of the condition of the user. The central application unit 104 may thus provide information to the user equipment 102 in order to directly direct the user equipment 102 to establish contact with the electronic commerce site 116. Hence, the application in the user equipment 102 may guide a user for easily ordering the necessary or recommended products.

The system 100 may further comprise an interface, such as an Application Programming Interface (API), for connecting an information editor 118 to the central application unit 104. The information editor 118 may allow general information or advice to be provided to all or selected users. For instance, an administrator may send information to users in specific regions regarding general advice that applies to those users. For an application to provide advice about treatment of a skin condition, such general advice may be a reminder to use sun blockage when summer season is approaching or when weather forecasts predict sunny weather. The information editor 118 may be used to manually push general advice to applications in user equipments 102 or to set a time when such general advice is to be transferred to user equipments 102.

The system 100 may also comprise an interface for connecting a publisher editor 120 to the central application unit 104. The publisher editor 120 may allow providing interesting information regarding the condition to users, e.g. by sending links to articles or to social media groups dedicated to the condition to the central application unit 104. The user may access the publisher information through a direct pointer provided in the application of the user equipment 102 or by being alerted about new publisher information in the application.

Information provided through the publisher editor 120 and/or advice provided through the information editor 118 may be transmitted to selected groups of users. The groups of users may be determined based on a filter, which may use parameter values that are defined for every user in order to select the users belonging to the group. For instance, the filter may use parameter values relating to type of condition, gender, age, home country, etc.

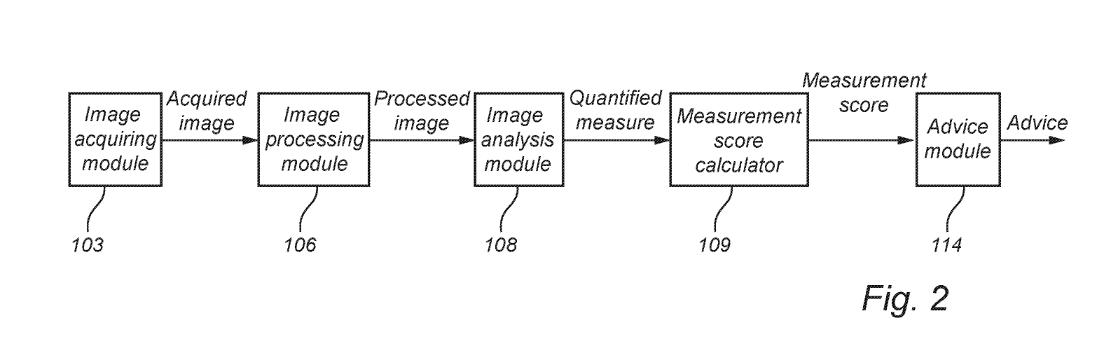

Referring now to FIG. 2, a block representation of a process of providing advice to a user is presented. First an image depicting the condition of the user is acquired by an image acquiring module 103. The image acquiring module 103 may be a camera, such as an embedded camera in a smart phone.

The acquired image may be transferred to the image processing module 106 for processing the image. The image processing module 106 may be configured to adapt the image to a standardized model. In this regard, the image processing module 106 may perform an image transformation on the acquired image such that the image is fitted to the standardized model. The image transformation may be an affine transformation of the image or part of the image to arrange specific features in the image at specific positions in the image.

The processed image may be transferred to the image analysis module 108. The image analysis module 108 may be arranged to extract measurement features in the image. The extracted measurement features may be compared to reference features in order to determine a quantified measure of the condition from the processed image. The image analysis module may thus output at least one quantified measure of the condition.

The at least one quantified measure of the condition is transferred to the measurement score calculator 109, which calculates a measurement score from the at least one quantified measure of the condition. The measurement score calculator 109 may comprise an algorithm for calculating a measurement score based on the at least one quantified measure of the condition.

The measurement score is transferred to the advice module 114, which may also receive further input, such as historical values of the measurement score for the user, personal information about the user, environment information, and an index score. The advice module 114 may apply the received input to rules such that appropriate advice for treatment of the condition may be generated or returned from the advice module 114.

The generated advice is transferred to the application in the user equipment 102, such that the advice may be presented to the user, e.g. by presenting the advice on a display of the user equipment 102.

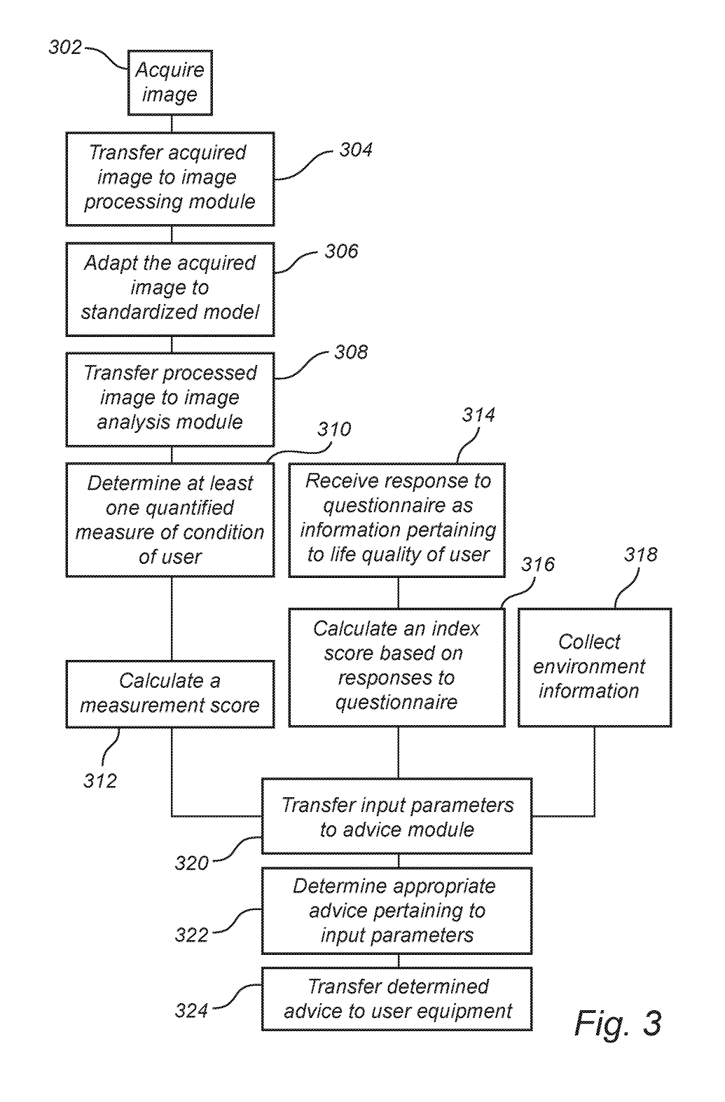

Referring now to FIG. 3, a method for providing advice to a user about treatment of a condition of the user will be described in further detail. The description of the method below will also make specific references to providing advice for the treatment of acne. It should be realized that advice may similarly be provided in relation to other types of conditions, such as other skin conditions, e.g. age wrinkles, wounds, burns, or psoriasis, or other conditions, e.g. discoloured teeth.

The central application unit 104 may prompt a user, e.g. by sending a notice to the application in the user equipment 102, to acquire an image depicting the condition. Thus, the central application unit 104 may control that images are acquired with a desired frequency, in order to allow progress of the condition to be monitored.

The central application unit 104 may also prompt input from the user in order to collect other information, such as personal information about the user or responses to a questionnaire.

Alternatively, the user may decide when to acquire an image depicting the condition. The application in the user equipment 102 may disable a function to acquire an image, such that an image depicting the condition may only be taken with at least a pre-defined interval between subsequent images. For instance, the application may only allow images to be taken once a day.

Thus, an image is acquired, step 302, by the user operating a camera 103 of the user equipment 102. In an embodiment to treat acne, the acquired image may depict a face of the user. The image may thus show the extent of acne in the user's face.

The acquired image may then be transferred to an image processing module 106, step 304. The acquired image may thus be received by the central processing unit 104 for further transfer to the image processing module 106.

The image processing module 106 may have access to a stored standardized model of depicting the condition. The standardized model may provide a reference of how specific features in the image should be placed in the image. The acquired image may then be adapted to the standardized model such that the specific features will always be placed in the same way in images to be analyzed.

In an embodiment, the image processing module 106 may be provided with program instructions for performing image processing. The image processing module 106 may thus be arranged to automatically extract image features in the image and processing the image in order to adapt the placement of the extracted image features to the placement of the image features in the standardized model.

The image processing module 106 may comprise filters for finding pre-defined features in the image. For instance, in an embodiment to treat acne, the image processing module 106 may be arranged to find a contour of a face of the user, by using an edge filter for extracting the contour. The image processing module 106 may further apply a filter to the acquired image for identifying a position of a feature corresponding to the filter in the image. For instance, the image processing module 106 may be arranged to find a position of e.g. eyes, mouth, or chin in the image. Placement of the extracted features in the image may be compared to placement of defined features in the standardized model. Using this comparison, the image processing module 106 may determine an image transformation that may adapt the placement of the extracted features in the image to the placement of the defined features in the standardized model.

The image processing module 106 may determine whether it would be possible to obtain a reliable measurement score based on the acquired image. For instance, if the image needs to be substantially transformed in order to adapt to the standardized model, the image processing module 106 may determine that no reliable measurement score may be obtained from the image. The user may then be prompted to acquire a new image.

In another embodiment, the image processing module 106 may be arranged to present the standardized model to a user for aiding the user to provide input for adapting the acquired image to the standardized model.

The application in the user equipment 102 may thus have access to the standardized model, e.g. by the standardized model being locally stored in a memory of the user equipment 102. Alternatively, the standardized model may be transferred from the central application unit 104 to the user equipment 102, when an image has been acquired.

The standardized model may comprise a stylized illustration of how the condition is to be depicted. For instance, the standardized model may outline a placement of a face in the image by providing a contour of a face in the image, or indications of placement of other features in the image. The stylized illustration may be suited for being superposed on the acquired image. The superposed standardized model and the acquired image may be presented to the user on a display of the user equipment 102. Alternatively, the standardized model and the acquired image may be presented in close relation to each other, such as side-by-side, on the display.

Alternatively, the standardized model may define specific features of the image and the user may be prompted to identify a location of the specific features in the image.

The user may provide input for transforming the acquired image in order for the acquired image to fit the standardized model. For instance, the user may provide zooming information for zooming into a part of the acquired image corresponding to the features disclosed in the standardized model. Alternatively, the user may be requested to input information of placement of certain features in the image, such as eyes, mouth, or chin in the image. The application in the user equipment 102 may be arranged to temporarily transform the acquired image based on input from the user and present the temporarily transformed image on the display, such that the user may confirm whether the input will adapt the acquired image to the standardized model. Once the user is satisfied with how the acquired image is to be adapted to the standardized model, the user may indicate that the current temporary transformation adapts the acquired image to the standardized model.

The user may thus be aided to provide processing input, which may e.g. be information of how to crop the image, for transforming the acquired image to adapt the acquired image to the standardized model. The processing input may be transferred together with the acquired image via the central application unit 104 to an image processing module 106.

Once a relation of the acquired image to the standardized model has been established, through input from the user or by automatic extraction of features in the image, the image processing module 106 may apply an image transformation to the acquired image for adapting the acquired image to the standardized model, step 306.

The image processing module 106 may further be arranged to determine characteristics of the acquired image and to process the image in order to adapt the characteristics to the standardized model. The characteristics may relate to lighting conditions, such as a histogram of pixel intensity values in the image. The standardized model may define desired characteristics and image processing may be applied to the acquired image for adapting the characteristics to the definitions of the standardized model. For instance, the pixel intensity values may be fitted to a desired range provided by the standardized model. This may be very useful to managing a user acquiring images in differing lighting conditions. Also, determined characteristics may be artifacts in the image, such as a bright spot due to a reflex being imaged. The acquired image may further be processed to remove any such determined artifacts.

The processed image may be transferred to an image analysis module 108, step 308. The image analysis module 108 may be arranged to determine at least one quantified measure of the condition of the user, step 310.

In an embodiment, the image analysis module 108 may be provided with program instructions for performing image analysis. The image analysis module 108 may thus be arranged to automatically extract measurement features in the processed image. The measurement features to be extracted may be pre-defined in the image analysis module 108. Since the processed image is adapted to a standardized model, the measurement features may be extracted from a specific, pre-defined location in the image. Alternatively or additionally, the image analysis module 108 may comprise information of reference features, which the image analysis module 108 may be used as basis for finding similar features in the processed image. For instance, the image analysis module 108 may be arranged to search the processed image using a filter based on reference features, in order to locate measurement features in the processed image. In an embodiment to treat acne, the image analysis module 108 may be provided with reference features relating to different forms of acne, such as pustules, papules, whiteheads, and blackheads. The image analysis module 108 may thus be arranged to search the acquired image for measurement features corresponding to each of the different forms of acne, and the number of identified occurrences of each form of acne in the processed image may be returned as quantified measures of the condition.

When acquiring an image, a reference patch may be depicted in the image. For instance, the user may place the reference patch against the skin before the image is acquired. The reference patch may comprise a number of fields having different colours, such that the reference patch may aid in analyzing features in the image. This implies that lighting conditions when acquiring the image may not need to be adjusted before image analysis, since the reference patch is present in the image and is equally affected by the imaging conditions as the features to be analyzed.

The image analysis module may thus first identify fields of the reference patch and may then extract measurement features in the image based on the fields of the reference patch. The reference patch may thus provide input as to filtering of the remaining image in order to extract measurement features of the processed image. In an embodiment to treat acne, the reference patch may provide typical colours associated with different forms of acne.

The reference patch may provide defined measures such that a size of a feature in the image may be determined by its relation to a feature on the reference patch having a known size.

The reference patch may be used to define a portion of the skin to be analyzed. The standardized model may be related to the reference patch. For instance, the reference patch may be a rectangular frame, defining an area to be analyzed inside the frame. Hence, the image processing module 106 may process the image to place the reference patch along the boundaries of the processed image such that an equally large test area is always analyzed in the acquired images.

In another embodiment, the image analysis module 108 may be arranged to present the processed image to a manual assessor. Although the use of a reference patch may be particularly useful for automated image analysis, it may also provide an aid to a manual assessor for analyzing the image. The manual assessor may be the user of the application having the condition to be treated. However, the manual assessor may alternatively be a professional being an expert in treatment of the condition. In such case, the processed image may be transferred to a computer unit to which the professional has access and presented on a display of the computer unit. The computer unit may execute an application providing an interface to the central application unit 104. The professional may thus analyze the processed image and may input the at least one measure of the condition through the interface to the central application unit 104.

When the manual assessor is the user, whose condition is to be treated, the image analysis module 108 may transfer the processed image to the application in the user equipment 102. The application may present a graphical interface on a display of the user equipment 102 allowing the user to provide input to the analysis of the processed image. The graphical interface may present the processed image together with a reference image, illustrating a typical condition to be quantified in the processed image. The user will thus be aided in finding measurement features in the processed image corresponding to the reference image. The user may for instance provide input of a number of identified occurrences of a feature corresponding to the reference image in the processed image as a quantified measure of the condition. The graphical interface may then present a sequence of reference images allowing the user to provide numbers of identified occurrences for each of the features illustrated by the reference images.

In order to further aid the user in analyzing the processed image, the graphical interface may further present a historical image of the user and a value of the quantified measure previously determined for the historical image. The historical image and the value of the quantified measure may be presented side-by-side with the processed image to be analyzed and the reference image, illustrating a typical condition. Hence, the user may compare the processed image to the historical image and may therefore be aided in providing a quantified measure of the condition by relating the quantified measure to the historical value. The historical image may be any previous image depicting the condition of the user, such as the first acquired image or the most recently acquired image.

In an embodiment to treat acne, the graphical interface may present reference images illustrating different forms of acne, such as pustules, papules, whiteheads, and blackheads. The user may thus be guided to search the acquired image for measurement features corresponding to each of the different forms of acne, and the number of identified occurrences of each form of acne in the processed image may be input to the graphical interface as quantified measures of the condition. A quantified measure of the condition may also be a status change relating to an appearance or disappearance of a form of acne. For instance, if the user has received a new form of acne or completely got rid of a form of acne, a binary number or a Boolean parameter representing such a status change may be used as a quantified measure of the condition.

A measurement score may be calculated, step 312, based on the at least one quantified measure of the condition. The measurement score may be calculated using an algorithm for relating a measurement score to the at least one quantified measure of the condition. For instance, in an embodiment to treat acne, the measurement score may be a value in the interval of 0 to 100 based on the number of occurrences of the different forms of acne in the processed image.

Also, a value defining the reliability may be determined which may indicate the reliability of the measurement score. The reliability may e.g. be dependent on an extent of transformation of the image and lighting conditions in the image.

The central application unit 104 may further prompt a user, e.g. by sending a notice to the application in the user equipment 102, to respond to a questionnaire pertaining to an impact on life quality of the user in relation to the user's perception of the condition. The central application unit 104 may be arranged to prompt the user to respond to the questionnaire with a pre-defined frequency, such as monthly.

The user may respond to the questionnaire by providing responses to questions through the application in the user equipment 102. The central application unit 104 may receive the responses, step 314, as information pertaining to the life quality of the user.

The questionnaire may comprise multiple-choice questions, whereby a score may be related to each response. The index score calculator 111 may calculate an index score, step 316, based on the responses to the questionnaire. The questionnaire may comprise standardized questions for psychological evaluations and the index score may also be related to standard evaluations of life quality based on a standardized evaluation.

The central application unit 104 may further collect environment information, step 318, through the environment information module 112. Thus, external parameters that may affect the condition of the user may be obtained.

Input parameters may be transferred to the advice module 114, step 320. The input parameters may be historical values of the measurement score of the user, personal information about the user, the calculated measurement score from step 312 and the value defining the reliability of the measurement score, subjective information of the user's experience of the condition, the calculated index score from step 316 and the environment information collected in step 318.

Other parameters may also be useful as input to the advice module 114. For instance, some or all of the quantified measures of the condition obtained from the image analysis may be used as input. In an embodiment to treat acne, a status change regarding appearance or disappearance of a form of acne may be provided as input to the advice module 114.

The advice module 114 may also receive as input information regarding previously provided advice and an indication of treatment results/how effective treatment of the condition has been using the previously provided advice for other users. Alternatively, the advice module 114 may have access to information on the previously provided advice and may fetch such information during a process of determining appropriate advice, e.g. when deciding which of a set of potentially appropriate advice to be used.

The previously provided advice may be associated with personal information about the user and/or further information of progress of treatment during treatment of the condition. This implies that the previously provided advice may be related to circumstances of the treatment, such that a pattern may be available for determining in which circumstances specific advice are effective. The advice module 114 may receive or fetch only previously provided advice that were provided for similar circumstances as currently applying to the user for which appropriate advice is to be determined.

By means of storing the previously provided advice in association with treatment results, the advice module 114 may be able to learn which advice that may be effective, such that the advice module 114 may improve its capacity to determine appropriate advice.

The advice module 114 may provide rules for correlating received input to advice for treatment of the condition. The advice module 114 may determine appropriate advice pertaining to the input parameters, step 322. The advice module 114 may use a combination of the input parameters in order to determine advice pertaining to the specific combination of the input parameters. However, the advice module 114 may alternatively apply different rules to different input parameters, such that separate advice based on separate types of input parameters may be obtained. As a further alternative, rules may be applied both to combinations of input parameters and to separate types of input parameters.

In an embodiment, the index score is used as a separate input parameter to one or more specific rules for determining advice. If the index score is above a pre-defined threshold value, the user may be in need of professional psychological help. If so, the advice module 114 may return advice to seek professional help. For index scores below the pre-defined threshold value, a positive feedback or advice may be given when the index score is improved, whereas encouraging feedback or advice may be given when the index score is worsened.

In an embodiment, the personal information about the user and the environment information may be combined as input to one or more rules for determining advice. Such advice may relate to general tips for helping the user to treat the condition in relation to current or coming external conditions. For instance, in an embodiment to treat acne or other skin conditions, the rules for determining advice may take the user's sun bathing habits and the weather forecast into account for e.g. providing advice of using a skin protection product if sunny weather is to be expected.

In an embodiment, the calculated measurement score and, optionally, the historical values of the measurement score of the user may be used as input to rules for determining specific advice pertaining to a state of the condition of the user. The advice module 114 may thus determine advice relating to an appropriate product and dosage to be used for treating the condition in relation to a current state of the condition.

The advice module 114 may comprise information of a typical progress of the measurement score during a treatment of the condition and tolerance ranges, wherein the measurement score normally varies. The calculated measurement score and the historical values may thus be compared to typical progress of the measurement score to determine whether the treatment is proceeding according to expected results of the treatment.

In an embodiment to treat acne, the measurement score may provide an indication of what form of acne is most frequently occurring in the user's skin. The advice module 114 may then use the measurement score as input for determining an appropriate treatment schedule. For instance, the advice module 114 may provide advice to the user relating to maintaining personal hygiene, or to a type of topical cream or gel to be applied to the skin and further details on when and how much cream should be applied.

In particular, the advice module 114 may compare the measurement score to a measurement score for the first acquired image when starting to treat the condition and to a measurement score of the last acquired image. The measurement score may provide a clinical aspect of a state of acne, with a lower score indicating an improved state. However, to a user, a reduction of number of pustules and papules may be more apparent. Therefore, comparison of quantified measures relating to the number of pustules and number of papules for the acquired image may also be made to the first acquired image and the last acquired image. Based on these comparisons, a large matrix of different combinations of parameters may be formed and the matrix may then be used for determining appropriate advice.

In a specific example, a girl has had a positive response to treatment of acne. Suddenly, a setback occurs and the state of acne condition is worsened. Since the user is a girl, the setback may likely be on account of hormonal fluctuations. The advice module 114 may then determine an encouraging advice to embolden the user to maintain the treatment. Hence, the advice may be “The treatment has previously provided good results. You have now had a minor setback, which may be due to natural hormonal fluctuations. Continue the treatment according to previous plan”.

The determined advice may be transferred, step 324, to the user equipment 102. The determined advice may thus be presented to the user on the display of the user equipment 102, e.g. as a list of advice. When the advice pertains to treatment of the condition using a specific product, a link to an electronic commerce site 116 from which the product may be purchased, may also be displayed. The link may lead directly to the purchase of the product on the electronic commerce site 116. Hence, the user may be able to order the product by following the direct link to the electronic commerce site 116 and accept the purchase of the product on the electronic commerce site 116.

A progress of the treatment of the condition may also be presented on the display of the user equipment 102. For instance, a graph illustrating the progress of the measurement score over time may be presented. Hence, the user may be provided with feedback regarding the progress of the treatment and may therefore be motivated to continue treatment of the condition.

A link to sharing the progress of the treatment on social media may also be presented on the display of the user equipment 102. In particular, if the progress of treatment of the condition of the user is exceptional, the user may be encouraged to share the progress on social media.

The user may also be able to trigger sending a message including specific information from the application to a selected receiver. For instance, an e-mail message may be transmitted from the user equipment 102 to a receiver. In this regard, the user may define information to be included in such a message. The user may e.g. want to include information of the progress of the measurement score over time and may also want to include specific acquired images, such as a first and a last acquired image.

A possibility to select information to be included in a message may be very helpful if the user wants to share progress of the condition with others, e.g. in order to obtain professional input on the treatment of the condition. Thus, in preparation of a meeting with a physician, the user may send an e-mail message from the application in the user equipment in order to provide the physician with all necessary information to give a professional opinion on the condition.

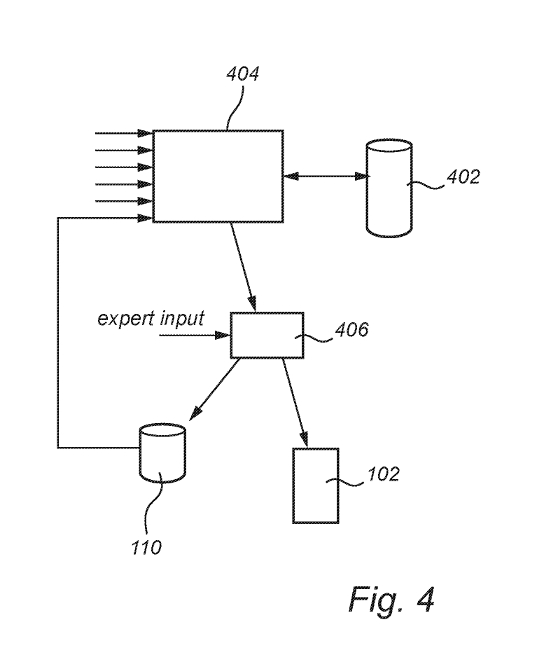

Referring now to FIG. 4, a more detailed description of the advice module 114 will be given.

The advice module 114 may be arranged to store a set of pre-defined advice in a database 402. The advice module 114 may be arranged to select one or more of the pre-defined advice, wherein the selected one or more advice may be appropriate to present to a user.

The advice module 114 may be arranged to receive a number of different input parameters, as described above. The advice module 114 may further comprise decision logic 404, wherein input is received to the decision logic 404 and processed by the decision logic 404 to determine the appropriate advice.

The input parameters may be directly compared to pre-defined parameter values in the decision logic 404. Alternatively, the advice module 114 may be arranged to process one or more input parameters to determine a value which may be compared to a pre-defined parameter value.

The decision logic 404 may comprise a matrix for determining appropriate advice based on a combination of results of comparison of input parameters to pre-defined parameter values. The decision logic 404 may alternatively comprise a decision tree for sequentially comparing input parameters to pre-defined parameter values until an appropriate advice has been determined.

According to an embodiment, one or more input parameters may have a high importance. Thus, if the decision logic 404 finds that the one or more important input parameters meet a pre-defined parameter value, a specific advice may be directly determined and there may be no further need to compare other input parameters to pre-defined parameter values. Thus, the appropriate advice may be directly determined and one or more comparisons of other input parameters to respective pre-defined parameter values may be skipped.

The advice module 114 may output one or more selected advice to a first interface 406, which may be accessible by a professional being an expert in treatment of the condition. The professional may determine which of the selected advice that is appropriate to present to the user and/or provide individual advice, before the advice is transferred to a user equipment 102.

Alternatively, the advice module 114 may output the one or more selected advice directly to the user equipment 102.

The advice module 114 may further store the selected advice that was transferred to the user equipment 102 in the database 110, or in a separate database, in relation to the user. Such previously selected advice may also be input to the advice module 114, when new advice is to be determined for the user.

The advice module 114 may also determine an effect of the treatment in relation to the selected advice so that an effectiveness of the advice on the treatment of users may be determined. This effectiveness may be used for updating the rules for determining appropriate advice in improving the advice module 114.

The advice module 114 may thus be self-learning and may be able to associate input parameters, to which advice that may be effective in the specific circumstances described by the input parameters.

Further, by means of enabling a professional to determine which of the selected advice that is appropriate to present to the user among one or more selected advice, the advice module 114 may learn from the determination by the professional which of the selected advice that is most appropriate. This may be used to further improve the capability of the advice module 114 to determine appropriate advice.

Thus, according to a separate aspect, which may or may not be combined with the method of providing advice as described above, there is provided a method of combining automatic determination of an advice to a user about treatment of a condition with a possibility for manual input, the method comprising, by an advice module: receiving historical values of a measurement score of the user, a current measurement score of the user, and personal information about the user as input, wherein the measurement score describes a state of the condition of the user; comparing received input to pre-defined parameter values for determining appropriate advice; selecting from a set of pre-defined advice a plurality of potentially appropriate advice; transferring the potentially appropriate advice for presentation to a professional; receiving input providing an indication of a determined advice among the potentially appropriate advice, which determined advice is appropriate advice according to the professional; and storing the determined appropriate advice in a database, wherein the advice module in selecting potentially appropriate advice uses previously determined appropriate advice.

Hence, the advice module 114 may use the input of a professional such that the advice module 114 may learn from input by the professional which advice that may be appropriate for future advice to be provided. By providing potentially appropriate advice to a professional, the professional may quickly determine which advice is actually appropriate, such that the input to be provided by the professional is not time-consuming for the professional.

Even though the present disclosure describes and depicts specific example embodiments, the invention is not restricted to these specific examples. Modifications and variations to the above example embodiments can be made without departing from the scope of the invention, which is defined by the accompanying claims only.

For example, the system has been described having a user equipment, which communicates with a central application unit. Although, the above description may present specific modules as being implemented or executed either in the user equipment or in the central application unit, it should be realized that execution of each module may be implemented in any of the user equipment or central application unit or may be shared to be performed partly by the user equipment and partly by the central application unit. For instance, execution of the image processing module, the image analysis module and the advice module may be performed on either of the user equipment or the central application unit or partly on both.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs appearing in the claims are not to be understood as limiting their scope.

1. A method for providing advice to a user about treatment of a condition of the user, said method comprising:
receiving an image of the user, wherein the image depicts the condition;
processing the image in relation to a standardized model of depicting the condition such that the image is adapted to the standardized model;
transferring the processed image to an analysis module;
receiving at least one quantified measure of the condition from the analysis module, wherein the quantified measure is based on the image;
calculating a measurement score based on the at least one quantified measure, the measurement score describing a state of the condition;
storing the image in a database in association with the at least one quantified measure and/or the calculated score;
transferring historical values of the measurement score of the user, the calculated measurement score, and personal information about the user as input to an advice module, which provides rules for correlating received input to advice for treatment of the condition;
processing, by the advice module, the received input in order to automatically determine appropriate advice for treatment of the condition; and
transferring the determined advice to an application for presenting the determined advice to a user.

2. The method according to claim 1, wherein said processing, by the advice module comprises comparing received input to pre-defined parameter values for determining appropriate advice and selecting from a set of pre-defined advice stored by the advice module, the appropriate advice corresponding to the received input based on said comparing.

3. The method according to claim 2, further comprising storing information indicating a previously selected advice for the user and said selecting of the appropriate advice being further based on the stored information indicating the previously selected advice.

4. The method according to claim 2, further comprising identifying specific input received by the advice module as particularly important, wherein said processing, by the advice module, comprises comparing said specific input to at least one pre-defined parameter value, and skipping at least one comparison of received input to pre-defined parameter values based on said specific input meeting the at least one pre-defined parameter value.

5. The method according to claim 1, wherein said processing of the image in relation to a standardized model comprises presenting a standardized model to a user for aiding the user in adapting the image to the standardized model, receiving processing input from the user relating the image to the standardized model, and processing the image using the processing input.

6. The method according to claim 1, wherein the standardized model comprises information of image features and placement of the image features in the standardized model, and wherein said processing of the image in relation to a standardized model comprises extracting image features in the image and processing the image in order to adapt the placement of the extracted image features to the placement of the image features in the standardized model.

7. The method according to claim 1, further comprising analyzing the processed image, by the analysis module, wherein said analyzing comprises extracting measurement features in the image; and comparing the extracted measurement features to stored definitions of features of interest in order to automatically determine said at least one quantified measure of the condition.

8. The method according to claim 1, further comprising presenting the processed image, by the analysis module, to a user together with a historical image of the user and a value of said at least one quantified measure of the condition as determined in the historical image in order to aid the user in determining said at least one quantified measure of the condition in the processed image.

9. The method according to claim 1, further comprising determining a point in time at which an image of the user is to be acquired and prompting the user to acquire the image.

10. The method according to claim 9, wherein said processing by the advice module is made in response to receiving an image of the user and receiving at least one quantified measure of the condition.

11. The method according to claim 1, further comprising receiving environment information describing external parameters that may affect the condition of the user, and transferring the environment information as input to the advice module.

12. The method according to claim 11, wherein said processing by the advice module is made in response to receiving updated environment information describing a change of said external parameters.

13. The method according to claim 1, wherein said condition of the user is a cosmetic condition, such as discoloured teeth or a skin condition, such as acne, or age wrinkles.

14. The method according to claim 1, further comprising receiving information pertaining to an impact on quality of life of the user in relation to the user's perception of the condition; calculating an index score of the impact on quality of life of the user; and transferring the index score as input to the advice module.

15. The method according to claim 1, further comprising determining a predicted result of the treatment based on the processed image, information of treatment results of previously performed treatments, and information about the treatment to be performed.

16. A computer program product comprising a computer-readable medium with computer-readable instructions for performing a method comprising:
receiving an image of a user, wherein the image depicts a condition;
processing the image in relation to a standardized model of depicting the condition such that the image is adapted to the standardized model;
transferring the processed image to an analysis module;
receiving at least one quantified measure of the condition from the analysis module, wherein the quantified measure is based on the image;
calculating a measurement score based on the at least one quantified measure, the measurement score describing a state of the condition;
storing the image in a database in association with the at least one quantified measure and/or the calculated score;
transferring historical values of the measurement score of the user, the calculated measurement score, and personal information about the user as input to an advice module, which provides rules for correlating received input to advice for treatment of the condition;
processing, by the advice module, the received input in order to automatically determine appropriate advice for treatment of the condition; and
transferring the determined advice to an application for presenting the determined advice to a user.

17. A system for providing advice to a user about treatment of a condition of the user, said system comprising:
an image processing module, said image processing module being configured to receive an image of the user, wherein the image depicts the condition and to process the image in relation to a standardized model of depicting the condition such that the image is adapted to the standardized model;
a measurement score calculator, said measurement score calculator being configured to receive at least one quantified measure of the condition, wherein the quantified measure is based on the image, and calculate a measurement score based on the at least one quantified measure, the measurement score describing a state of the condition;
a database storing the image in association with the at least one quantified measure and/or the calculated score; and
an advice module, said advice module being configured to receive historical values of the measurement score of the user, the calculated measurement score, and personal information about the user as input, said advice module providing rules for correlating received input to advice for treatment of the condition and being further configured to process the received input in order to automatically determine appropriate advice for treatment of the condition.

18. The method according to claim 3, further comprising identifying specific input received by the advice module as particularly important, wherein said processing, by the advice module, comprises comparing said specific input to at least one pre-defined parameter value, and skipping at least one comparison of received input to pre-defined parameter values based on said specific input meeting the at least one pre-defined parameter value.
